(19) United States
(12) Patent Application Publication
(10) Pub. No.: US 2019/0182532 A1
(43) Pub. Date: Jun. 13, 2019

(54) METHOD AND SYSTEM FOR FAST CHANNEL SCAN FOR DOCSIS CABLE MODEM

(71) Applicant: Intel Corporation, Santa Clara, CA (US)

(72) Inventors: Bernard Arambepola, Enfield (GB); Ziv Kfir, Yavne (IL)

(73) Assignee: Intel Corporation, Santa Clara, CA (US)

(21) Appl. No.: 16/185,465

(22) Filed: Nov. 9, 2018

Related U.S. Application Data
(63) Continuation of application No. 14/592,512, filed on Jan. 8, 2015, now abandoned.

(51) Int. Cl. H04N 21/426; H04L 27/26; H04N 21/61

(52) U.S. Cl. CPC H04N 21/42676; H04L 27/2657; H04L 5/0048; H04N 21/6118; H04L 27/2675; H04L 27/2666

(57) ABSTRACT

The disclosure generally relates to a method and system for fast channel scan for DOCSIS cable modems. The disclosed exemplary embodiments are directed to hybrid fiber coaxial (HFC) modems and may be equally applied to other type of modems both wired and wireless. The disclosed embodiments enable locating the Physical Link Layer Chanel (PLC) quickly by using a beacon channel at a designated frequency offset from the PLC.

### CROSS-REFERENCE TO RELATED APPLICATIONS

This application is a continuation of U.S. patent application Ser. No. 14/592,512, filed on Jan. 8, 2015, and entitled METHOD AND SYSTEM FOR FAST CHANNEL SCAN FOR DOCSIS CABLE MODEM. The disclosure of the prior application is considered part of and is hereby incorporated by reference in its entirety in the disclosure of this application.

### BACKGROUND

### Field

The disclosure relates to a method, apparatus and system for fast channel scan for DOCSIS cable modems.

### Description of Related Art

Data Over Cable Service Interface Specification (DOCSIS) is an international telecommunications standard. DOCSIS permits the addition of high-bandwidth data transfer to an existing cable TV (CATV) system and is employed by CATV operators to provide Internet access over the existing hybrid fiber-coaxial (HFC) infrastructure. The DOCSIS standard uses conventional modems to provide gateway access to the internet. The latest version of the standard is DOCSIS 3.1 which was released in October 2013. It purports to support capacities of at least 10 Gbit/s downstream and 1 Gbit/s upstream using 4096 quadrature amplitude modulation (QAM). The new standard uses 6 and 8 MHz wide channel spacing and instead uses smaller (20-50 kHz wide) orthogonal frequency-division multiplexing (OFDM) subcarriers. The OFDM subcarrier can be bonded inside a block spectrum that can be about 200 MHz wide.

The DOCSIS architecture includes two primary components: a cable modem (CM) located at the customer premises, and a cable modem termination system (CMTS) located at the CATV headend. Cable systems supporting on-demand programming use a hybrid fiber-coaxial system. Fiber optic lines bring digital signals to system nodes where they are converted into RF channels and modem signals on coaxial trunk lines.

The conventional DOCSIS channel scan uses the physical layer link channel (PLC). Each 192 MHz DOCSIS channel contains a 400 KHz PLC embedded anywhere within it. The receiver, and once detected, Low Density Parity Check (LDPC) decode the PLC to get information on the main data channels. However, to get at the PLC, the receiver has to first search and detect the FFT size and the cyclic prefix size. Then it has to synchronize to the channel. The bandwidth of a DOCSIS channel may be as large as 192 MHz or as narrow as 24 MHz. Furthermore, there may be legacy single-carrier QAM channels and other video channels embedded within the DOCSIS channel. Searching for the PLC in 1.8 GHz of cable bandwidth can be very time consuming. Therefore, there is a need for quick searching and capturing an OFDM- DOCSIS channel.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 schematically shows an environment for implementing an embodiment of the disclosure;

FIG. 2 illustrates the relationship between the various component of data delivery system;

FIG. 3 schematically shows an exemplary embodiment of the disclosure;

FIG. 4 shows a flow diagram of one implementation according to the disclosed embodiments; and

FIG. 5 shows an exemplary device for implementing an embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12-TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

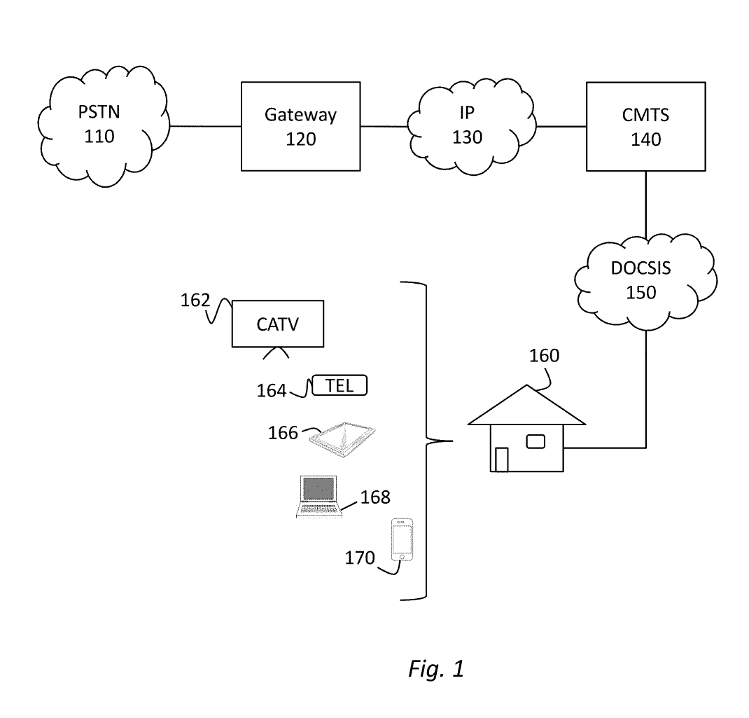

Certain embodiments of the disclosure may be implemented at a subscriber's premises using one or more of the disclosure implementations. FIG. 1 schematically shows an environment for implementing an embodiment of the disclosure. In FIG. 1, Public Switched Telephone Network (PSTN) 110 communicates with Internet Protocol (IP) network 130 through gateway 120. Gateway 120 may be any conventional switching network. CMTS 140 is a transmission gateway equipment conventionally located at the cable company's headend or hub location. Conventionally, CMTS provides high speed data services including Cable Internet or voice over Internet Protocol to cable subscribers.

CMTS 140 communicates with DOCSIS 150 as an interface between CMTS 140 and home subscriber 160. DOCSIS 150 permits the addition of high-bandwidth data transfer to an existing cable TV system for subscriber 160. As shown in FIG. 1, home subscriber 160 receives a variety of services from CMTS 140. The services include, for example, Cable TV (CATV) 162, DTMS telephone 164, and internet access for laptop 168, laptop 168 and smartphone 170. The internet access may be over a Wi-Fi router or a modem (collectively, Access Point (AP)). While shown apart from home subscriber 160, DOCSIS 150 may be incorporated in an AP residing at the subscriber's premises. In one embodiment, the disclosed embodiments are implemented on the Docsis PHY layer only.

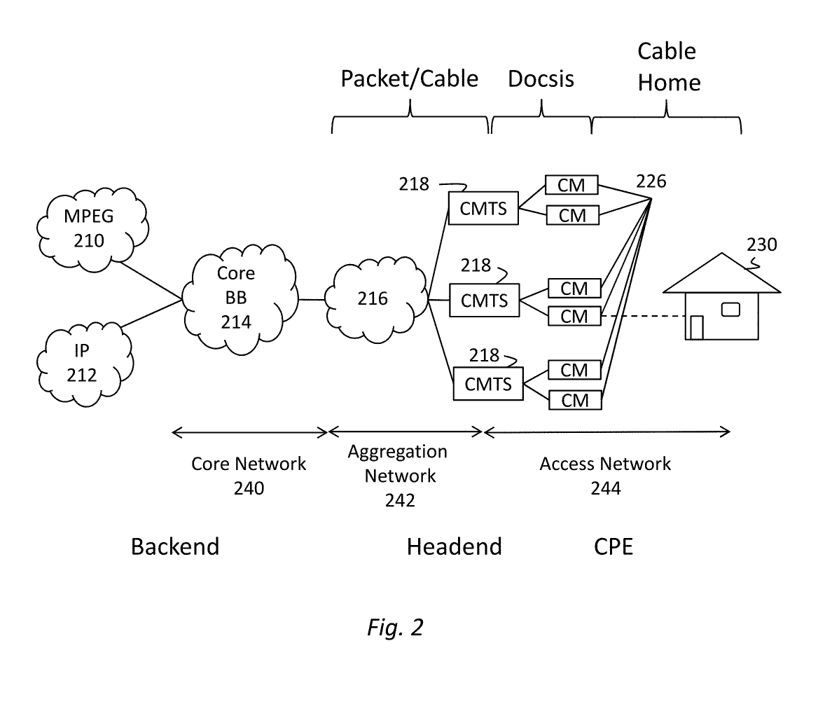

FIG. 2 illustrates the relationship between the various component of data delivery system. In FIG. 2, motion picture expert group (MPEG) services (e.g., motion picture) data 210 and IP service data 212 are provided to operator core backbone 214. Operator core backbone 214 defines Core Network 240 of an exemplary cable service provider. Services that may be provided by the backend architecture to the subscriber include: fire sensing and control, security, air quality monitoring and other managed services.

Operator core backbone 214 provides packet data to operator aggregation network 216, which relays data to one or more CMTS 218. The data may include both packet data from IP network 212 and cable data from MPEG network 210. Each CMTS communicates with one or more subscriber access network though subscriber modem 226. The operator aggregation network 216 and a portion of the CMTS define Aggregation Network 242. Cable modems 226 may be installed at the subscriber's residence 230 or office. The backend of the CMTS, the CM and the subscriber's access point 230 define Access Network 244. The distribution network of FIG. 2 may also be divided into the following portions: Backend 250, headend 252 and Customer Premises Equipment (CPE) 254.

In order to provide high speed data services, a cable company will connect its headend 252 to the Internet via very high capacity data links to a network service provider (e.g., IP 212). On CPE 254 side of headend 252, the CMTS enables the communication with CM 226 of subscriber 230. Different CMTSs are capable of serving different cable modem population sizes. A given headend may have between 1-12 CMTSs 218 to service the cable modem population served by that headend.

Conventional CMTSs may carry only IP 212 traffic. Traffic destined for the cable modem from the Internet, known as downstream traffic may be carried in IP packets encapsulated according to DOCSIS standard. The packets are mapped into bit streams, encoded and quadrature amplitude modulated on to OFDM subcarriers. Given the volume of incoming data to the customer's premises 230, locating the PLC in a 1.8 GHz bandwidth is time consuming and inefficient. As stated, conventional channel scan of DOCSIS modems use the PLC. Each 192 MHz DOCSIS channel contains a 400 KHz PLC embedded therein. The receiver (or CM 226) will have to detect and LDPC decode the PLC to obtain information on the main data channels.

To identify the PLC, conventional DOCSIS receivers first search and detect Fast Fourier Transform (FFT) size and the cyclic prefix size. The cyclic prefix refers to the prefixing of a symbol with a repetition of the end. Although the receiver is typically configured to discard the cyclic prefix samples, the cyclic prefixes serve two purposes. First, they act as a guard interval to eliminate the intersymbol interference from the previous symbol. Second, they act as a repetition of the end of the symbol to allow the linear convolution of a frequency-selective multipath channel to be modelled as circular convolution which may be transformed to the frequency domain using a discrete Fourier transform. This approach allows for simple frequency-domain processing, such as channel estimation and equalization.

The conventional scanning method is slow and inefficient because it has to first identify the FFT size and the cyclic prefix size. This is achieved through cyclic prefix correlation and spectral analysis. Since the OFDM bandwidth is variable and because there are so many non-OFDM signals in the channel, this correlation has to be done over small bandwidths. Hence the search frequency has to be moved in small steps, and as a result the search is time consuming.

After searching and detecting the FFT size and the cyclic prefix size, the conventional receiver has to synchronize to the PLC channel. The bandwidth of the DOCSIS channel may take any value up to 192 MHz or it may be as narrow as 24 MHz. In addition, there may be legacy single carrier QAM channels and other video channels embedded within the DOCSIS band. Therefore, searching for the PLC in 1.8 GHz of cable bandwidth is time consuming and inefficient.

The disclosed embodiments enable DOCSIS channel scan without searching for FFT or cyclic prefix. The disclosed embodiments do not require synchronization or equalization. Accordingly, the disclosed embodiment are significantly faster and more efficient than the conventional methods and systems.

In one embodiment of the disclosure, a reference or a beacon channel is provided as a pointer to the PLC location. The beacon channel may be configured at a known frequency offset from the PLC.

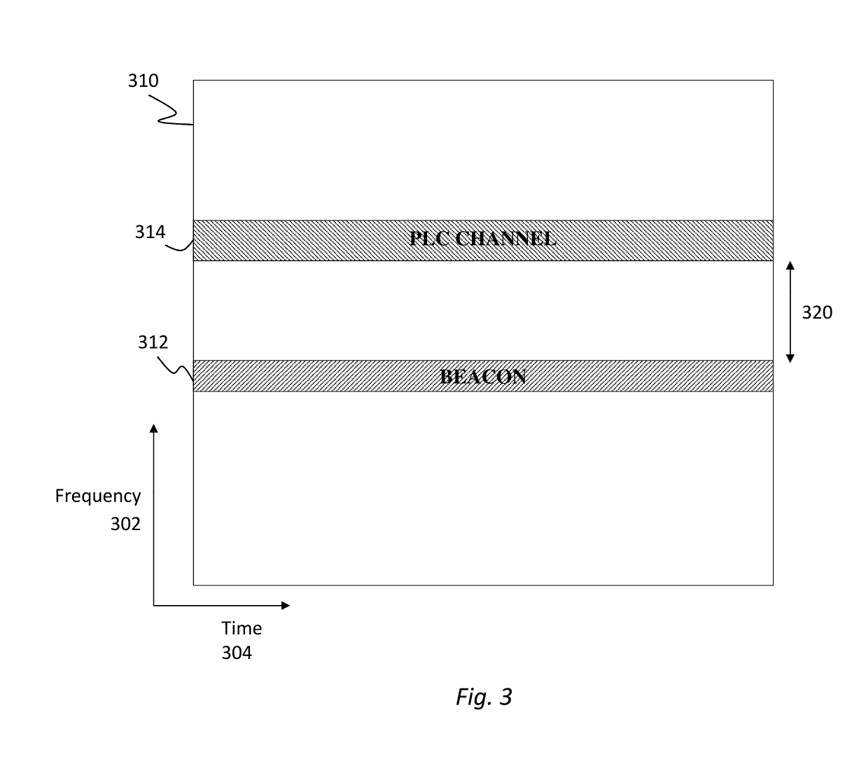

FIG. 3 schematically shows an exemplary embodiment of the disclosure. In FIG. 3, spectrum 310 represents an exemplary DOCSIS channel along frequency axis 302 and time axis 304. In FIG. 3, beacon channel 312 is designated at predefined frequency away from PLC channel 314. In this manner, beacon channel 312 will act as a pointer to PLC 314 channel.

In certain embodiments, the CMTS may be configured to place PLC 314 at a desired location on the spectrum and use beacon 312 channels subcarriers (not shown) to indicate the presence of the PLC. The receiver can easily and quickly locate beacon 312.

The beacon channel is formed of OFDM subcarriers. There are two possible FFT sizes for the main channel: 8K and 4K, with subcarrier spacing of 25 and 50 kHz, respectively. However, the beacon channel will use one subcarrier spacing irrespective of the subcarrier spacing of the main OFDM channel. This allows the beacon to be detected without a search for the FFT size. Furthermore, the beacon channel will use the smaller subcarrier spacing of 25 kHz, since with this spacing it is possible to make the beacon subcarriers orthogonal to the subcarriers of both 4K and 8K FFTs as explained below. The FFT of an OFDM subcarrier is a sinc function. If a beacon subcarrier frequency is f_{c} then the zeroes of the sinc function centered at f_{c} are at frequencies (f_{c}±25 kHz). The zeroes of this function will coincide with the OFDM subcarriers of a 4K FFT that are spaced 50 kHz apart and also with OFDM subcarriers of an 8K FFT that are spaced 25 kHz. As a result, the beacon channel will not introduce any interference to the data channel, irrespective of the size of the FFT used for the data channel.

In one embodiment, the beacon channel may be formed of eight subcarriers that are spaced 25 kHz. Each subcarrier may be BPSK modulated. The BPSK modulation of all eight subcarriers need not be the same. An 8-point pseudo-random sequence may be used to BPSK-modulate the eight subcarriers.

The time domain signal for the beacon channel is formed by taking the 8K-point inverse FFT. Since there are only 8 subcarriers, the other 8184 inputs to the IFFT are set to zero. In the time domain the 8192 samples of the beacon signal are repeated periodically. As far as the main data channel is concerned, the 8 subcarriers of the beacon channel are excluded subcarriers. DOCSIS 3.1 standard specifies a subset of subcarriers as excluded. Thus, the data channel will not attempt to decode the excluded subcarriers. Therefore, the beacon channel may be introduced while complying with the DOCSIS 3.1 specification.

At the receiver an 8K-point FFT of the broadband 192 MHz wide input signal is computed. The DOCISY 3.1 channel may only be 24 MHz wide and the channel may only be partially within the 192 MHz bandwidth. Therefore the 192 MHz signal may contain a beacon signal as well as many other OFDM and non-OFDM signals.

Assume that Y₁(k) and Y₂(k), k=0, 1, . . . , 8191 may be the FFTs of two successive 8192-point samples. Although the transmitter signals are BPSK, the received signals will be equal to the transmitted signal convolved with the channel impulse response which is a function of the micro-reflections in the channel. In the frequency domain, this is equivalent to multiplying the transmitted signal by the channel frequency response. Hence, for beacon subcarriers:

Y₁(k)=H(k)X(k) (1)

Y₂(k)=H(k)X(k) (2)

The channel frequency response does not change rapidly with time and hence is taken to be the same for both FFTs. Similarly, the data sequence is also periodic at the transmitter and hence the left hand sides of both Equations (1) and (2) are the same.

At the receiver individual subcarriers successive FFTs are differentially demodulated. This gives:

Y₁(k)Y*₂(k)=|H(k)X(k)|² (3)

Hence, for each subcarrier differential demodulation eliminates the phase component and yields only a magnitude. The differentially demodulated subcarriers are accumulated over time. Since they do not have a phase component, they are added coherently, resulting in relatively large amplitudes at the locations of the preamble subcarriers. After this accumulation along the time dimension, the frequency dimension is scanned to detect eight successive subcarriers with large amplitude. This may be achieved using 8-point moving average filter.

The above description assumes that the preamble subcarriers are aligned with the frequencies of the 8K-point FFT. This will not necessarily be the case because there is no frequency synchronization at this time. For example, the beacon subcarriers may be in the middle of two successive 8K FFT frequencies.

To overcome this problem, in one embodiment a poly-phase filter may be used to interpolate between successive 8K FFT frequencies. For example, the frequency range between two successive 8K FFT frequencies may be subdivided into 16 frequencies through the process of interpolation. Then the differential demodulation and subsequent accumulation may be done individually on these sub-divided frequencies. If the preamble exists in the 192 MHz band, then one of these frequencies will be close enough to the preamble frequency to give relatively large amplitude. The moving average filter may be applied, but now accumulating samples that are 16 points apart in the frequency domain. Thus, the moving average takes the form a comb filter.

The application of the interpolating filter may be computationally complex. The complexity may be reduced by computing a 128K-point FFT instead of an 8K FFT. This will automatically implement the interpolation by 16 along the frequency dimension. In certain embodiments, the longer FFT approach may be appropriate if the algorithm is implemented using a software processor.

Referring again to FIG. 3, once beacon 312 is located, it can readily point to PLC 314 location. In one implementation, the receiver may obtain a record of all the DOCSIS channels (Spectral Plan) in the 1.8 GHz spectrum. While every OFDM channel has an associated PLC, the beacon may be required only to point one of the PLCs. The beacon may provide information about all the channels in the system. The disclosed embodiments have significantly lower overhead requirement. For example, the bandwidth requirement may be less than 200 KHz. The disclosed embodiments may also be implemented without affecting DOCSIS compliant transmissions.

In one embodiment of the disclosure, beacon signal 312 may include a few OFDM subcarriers occupying a bandwidth of about 200 KHz. In an exemplary embodiment, eight OFDM subcarriers may be selected. The assigned subcarriers may be excluded so that other modems do not use the same subcarriers. In certain embodiments, the subcarriers are designed such that a simple receiver can be configured detect the subcarriers quickly using a wideband FFT search. The CMTS (See FIG. 2) may ensure that the PLC 314 is located at a per-defined frequency offset from the designated subcarriers so as to enable their detection. The designated subcarriers may thus act a pointer to the PLC frequency location.

The subcarriers may be BPSK modulated by a known sequence such as a pseudo random binary sequence (PRBS). The modulation from subcarrier to subcarrier may be different. In one embodiment, the modulation may be the same for every symbol. Therefore, symbol timing synchronization may not be needed to detect the subcarriers. It should be noted that in certain embodiments, the cyclic prefix is also not needed. Finally, the need for channel equalization is removed by differential demodulation at the receiver.

The DOCSIS standard includes two subcarrier spacing at 25 and 50 kHz. The exemplary eight reference subcarriers may use one of the two spacing. In one embodiment, the reference subcarriers use a smaller spacing of 25 kHz and thereby remove the need to search for the FFT size.

The disclosed embodiments obviate the need for symbol timing synchronization or cyclic prefix because symbol modulations in successive symbols are the same. Any phase slope due to symbol triggering as well as any channel frequency responses is removed by differential demodulation (along time axis) because these are approximately the same in successive symbols. In one implementation, the receiver (e.g., CM 226, FIG. 2) first implements a wideband FFT search covering the entire channel (e.g., 200 MHz bandwidth). Then the receiver identifies the frequency location of the set of reference subcarriers.

The CMTS (218, FIG. 2) ensure that the PLC is located at a pre-defined frequency offset from the set of reference subcarriers. In other words, the reference subcarriers act as a beacon to point to the PLC. In one embodiment, the CMTS at the headend (252, FIG. 2) place the PLC (314 FIG. 3) at a desired frequency in the spectrum and then place the beacon (312, FIG. 3) to indicate its presence. The CMTS may place the PLC in an substantially interference-free part of the spectrum (i.e., clean space). The clean space may vary from HFC plant to plant caused by interference from other signals (e.g., LTE signals coupled to cable at weak point on the cable insulation or sockets.

Therefore, the location of the PLC may be devised on a case-by-case basis. The receiver (CM 226, FIG. 2) can easily and very quickly locate the beacon, and from this it can find the PLC. This enables the receiver (CM 226, FIG. 2) to get a record of all the DOCSIS channels in the 1.8 GHz spectrum significantly faster than the conventional methods.

It should be noted that every OFDM channel has a PLC. However, the beacon is required only to point to one of the PLCs because it is possible to get information about all the channels in the system from one PLC. In certain embodiments, the overhead is small, for example, around 200 kHz. It can be implemented without affecting DOCSIS-compliant transmissions.

In another exemplary embodiment, different modulations schemes are applied to different beacon signals to provide multiple types of beacon signals. Thus, the receiver may also detects the type of beacon in addition to detecting the beacon signal. In certain embodiments, beacon type may be used indicate FFT size of the actual channel containing the PLC and the length of its cyclic prefix. This may not be necessary, however, because once the PLC location is detected it is relatively easy to detect the FFT size and cyclic prefix length using cyclic prefix auto-correlation.

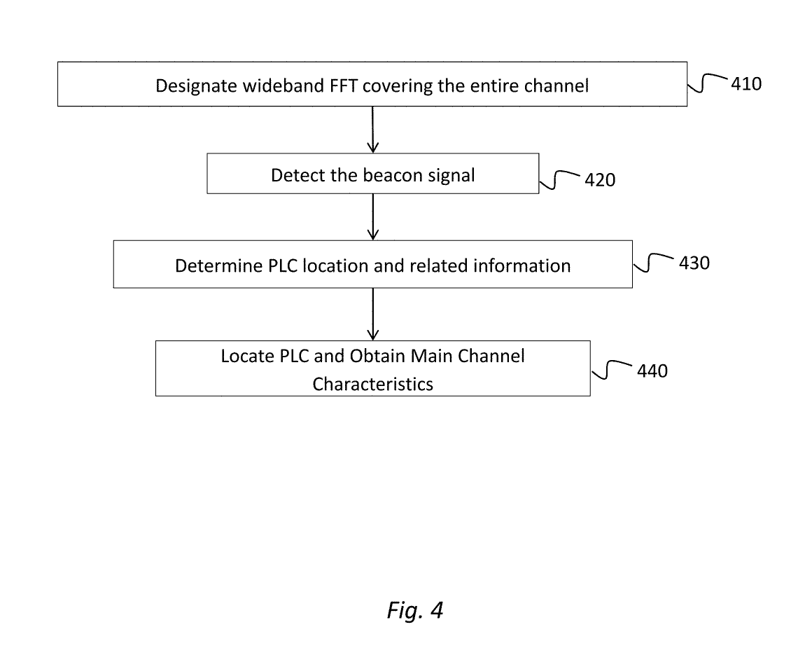

FIG. 4 shows a flow diagram of one implementation according to the disclosed embodiments. The flow diagram of FIG. 4 may be implemented at a cable modem such as CM 226 of FIG. 2. In one embodiment, the steps of the flow diagram are implemented as logic on a processor circuitry in communication with a memory circuitry. In another embodiment, the steps shown in FIG. 4 are implemented in hardware, software or a combination of hardware and software. In an exemplary embodiment, the hardware does the calculations and pass the results to the software to make the final decision. In an exemplary embodiment, the signal processing functions may be implemented in hardware in real time. In an alternative embodiment, the hardware may collect the data and pass the data to the software for processing.

The flow diagram of FIG. 4 starts at step 410 by designating search criteria. For example, the search may include conducting a wideband search of the DOCSIS channel. The search may include 8K FFT covering 204.8 MHz at 25 KHz spacing. The FFT search may be directed to finding a beacon signal through reference subcarriers.

At step 420, the beacon signal may be detected. Detecting the beacon signal may include known detection techniques. In one exemplary implementation, signal detection may include differential demodulation along the time axis (see, e.g., FIG. 3) along with testing several functional frequency offsets through frequency interpolation. The frequency interpolation may be done because the CM frequency may not have been synchronized. The results may be accumulated over several FFTs.

If the beacon signal is detected at step 420, at step 430 the PLC location may be readily determined. Consistent with an embodiment of the disclosure, the PLC location may be at a fixed offset from the beacon. Thus, once the beacon location is determined, the offset may be retrieved from an associated memory circuit to calculate the PLC location. In an exemplary embodiment where side information (e.g., beacon type, modulation type, etc.) is applied, other parameters of the main PLC channel such as FFT size and cyclic prefix may also be obtained at this step.

At step 440, the CM is tuned to PLC to detect the FFT and cyclic prefix size through auto-correlation. As part of step 440, the FFT may be computed and the PLC may be demodulated and decoded to get the main channel characteristics. In addition, frequency plan of the network may also be determined at step 440.

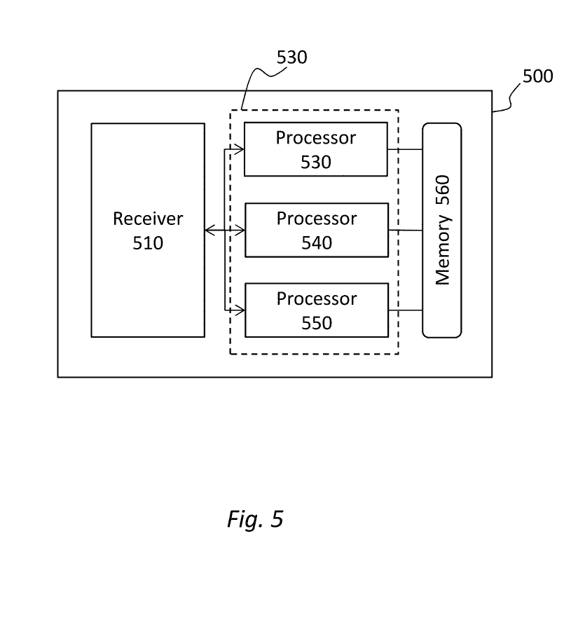

FIG. 5 is an exemplary apparatus according to one embodiment of the disclosure. Apparatus 500 of FIG. 5 may be a CM or any DOCSIS AP. Apparatus 500 may include receiver circuitry 510 to communicate with CMTS or other headend equipment to receive wideband data therefrom. Processor circuitry 530 may include a plurality of processors 530, 540 and 550. In an alternative embodiment, each of processors 530, 540 and 550 may define a processor module. Processors circuitry 530 may communicate with memory 560. Memory 560 may store instructions to be implemented in processor circuitry 530. The instructions may include one or more of the flow diagram steps of FIG. 4. In still another embodiment, processor circuitry 530 and memory 560 may be implemented in software.

In one embodiment of the disclosure, apparatus 500 communicates with a headend device (not shown). Receiver 510 receives information signaling information from the headend and designate a wideband FFT search covering the entire channel. The search may be organized by one or more of the processors 530, 540 or 5540. The FFT search may include wideband 8K FFT search covering the entire channel. Once a beacon is detected, information may be decoded or determined from the beacon signal's type and characteristics as discussed above. The processor circuitry may retrieve information about the location of PLC with respect to the beacon channel from Memory circuitry 560. This information may be then be processed to receiver 510 which may use this information to tune to the PLC and detect the FFT and cyclic prefix size. Receiver 510 may also decode the PLC to get the main channel characteristics as well as extract the frequency plan of the network from the PLC. In one embodiment, the

PLC will contain sufficient information to decode the data channel containing PLC. Once the receiver is locked onto the main data channel, it can obtain the frequency plan through the main channel or the PLC channel.

Example 1 is directed to an apparatus, comprising: a transceiver; and a logic, at least a portion of which is in hardware, the logic configured to conduct a wideband FFT search of the communication channel to identify frequency location of a set of beacon reference subcarriers, and to detect a Physical Layer Channel (PLC) location as a predefined frequency offset from the set of beacon reference subcarriers.

Example 2 is directed to the apparatus of example 1, wherein the PLC contains frequency information for all Data Over Cable Service Interface Specification (“DOCSIS”) channels in the spectrum.

Example 3 is directed to the apparatus of example 1, wherein the beacon reference subcarrier occupy about 200 kHz overhead.

Example 4 is directed to the apparatus of example 1, wherein the PLC defines a DOCSIS 3.1 channel.

Example 5 is directed to the apparatus of example 1, wherein the logic operates on a DOCSIS-compliant transmission.

Example 6 is directed to the apparatus of example 1, wherein the logic is further configured to detect a plurality of beacon channel reference subcarriers.

Example 7 is directed to the apparatus of example 6, wherein the beacon channel reference subcarriers are spaced 25 KHz apart.

Example 8 is directed to the apparatus of example 6, wherein the logic further detects FFT size of the PLC and the length of its cyclic prefix as a function of the beacon type.

Example 9 is directed to the apparatus of example 1, wherein the logic is further configured to detect the cyclic prefix length using cyclic prefix auto-correlation.

Example 10 is directed to a computer-readable storage device containing a set of instructions to cause a computer to perform a process comprising: conducting a wideband FFT search of the communication channel to identify frequency location of a set of beacon reference subcarriers; detecting a Physical Layer Channel (PLC) location at a predefined frequency offset from the set of beacon reference subcarriers; accessing the PLC at the predefined frequency offset to obtain information transmitted through the PLC.

Example 11 is directed to the computer-readable storage device of example 10, wherein the PLC contains frequency information for Data Over Cable Service Interface Specification (“DOCSIS”) channels in the spectrum.

Example 12 is directed to the computer-readable storage device of example 10, wherein the beacon reference subcarrier occupy a about 200 kHz overhead.

Example 13 is directed to the computer-readable storage device of example 10, wherein the PLC defines a DOCSIS 3.1 channel.

Example 14 is directed to the computer-readable storage device of example 10, wherein the PLC defines a DOCSIS-compliant channel.

Example 15 is directed to the computer-readable storage device of example 10, wherein the instructions further comprise detecting type of beacon reference subcarriers.

Example 16 is directed to the computer-readable storage device of example 15, wherein the instructions further cause the processor to detect FFT size of the PLC and the length of its cyclic prefix as a function of the beacon type.

Example 17 is directed to the computer-readable storage device of example 10, wherein the instructions further cause the computer to detect the FFT size and cyclic prefix length using cyclic prefix auto-correlation.

While the principles of the disclosure have been illustrated in relation to the exemplary embodiments shown herein, the principles of the disclosure are not limited thereto and include any modification, variation or permutation thereof.

What is claimed is:

1. An apparatus, comprising:
a transceiver; and
a logic, at least a portion of which is in hardware, the logic configured to conduct a wideband FFT search of the communication channel to identify frequency location of a set of beacon reference subcarriers, and to detect a Physical Layer Channel (PLC) location as a predefined frequency offset from the set of beacon reference subcarriers.

2. The apparatus of claim 1, wherein the PLC contains frequency information for all Data Over Cable Service Interface Specification (“DOCSIS”) channels in the spectrum.

3. The apparatus of claim 1, wherein the beacon reference subcarrier occupy about 200 kHz overhead.

4. The apparatus of claim 1, wherein the PLC defines a DOCSIS 3.1 channel.

5. The apparatus of claim 1, wherein the logic operates on a DOCSIS-compliant transmission.

6. The apparatus of claim 1, wherein the logic is further configured to detect a plurality of beacon channel reference subcarriers.

7. The apparatus of claim 6, wherein the beacon channel reference subcarriers are spaced 25 KHz apart.

8. The apparatus of claim 6, wherein the logic further detects FFT size of the PLC and the length of its cyclic prefix as a function of the beacon type.

9. The apparatus of claim 1, wherein the logic is further configured to detect the cyclic prefix length using cyclic prefix auto-correlation.

10. A computer-readable storage device containing a set of instructions to cause a computer to perform a process comprising:
conducting a wideband FFT search of the communication channel to identify frequency location of a set of beacon reference subcarriers;
detecting a Physical Layer Channel (PLC) location at a predefined frequency offset from the set of beacon reference subcarriers;
accessing the PLC at the predefined frequency offset to obtain information transmitted through the PLC.

11. The computer-readable storage device of claim 10, wherein the PLC contains frequency information for Data Over Cable Service Interface Specification (“DOCSIS”) channels in the spectrum.

12. The computer-readable storage device of claim 10, wherein the beacon reference subcarrier occupy about 200 kHz overhead.

13. The computer-readable storage device of claim 10, wherein the PLC defines a DOCSIS 3.1 channel.

14. The computer-readable storage device of claim 10, wherein the PLC defines a DOCSIS-compliant channel.

15. The computer-readable storage device of claim 10, wherein the instructions further comprise detecting type of beacon reference subcarriers.

16. The computer-readable storage device of claim 15, wherein the instructions further cause the processor to detect FFT size of the PLC and the length of its cyclic prefix as a function of the beacon type.

17. The computer-readable storage device of claim 10, wherein the instructions further cause the computer to detect the FFT size and cyclic prefix length using cyclic prefix auto-correlation.
